(19) United States
(12) Patent Application Publication
(10) Pub. No.: US 2010/0101871 A1
(43) Pub. Date: Apr. 29, 2010

(54) Weight checking conveyor with adjustable infeed section

(76) Inventor: Christopher Dale, Studley (GB)

Correspondence Address: Eric J. Fenzl, 453 85 Circle, College Park, GA, 30349, US

(21) Appl. No.: 12/589,147

(22) Filed: Oct. 19, 2009

Related U.S. Application Data
(60) Provisional application No. 61/197,354, filed on Oct. 27, 2008.

(51) Int. Cl. G01G 9/00

(52) U.S. Cl. 177/1

(57) ABSTRACT

An automatic conveyor comprising an angularly adjustable infeed, check weighing, and take-away sections. The conveyor relies on a pivotal infeed section with no frontal supporting structure to reduce the clearance required between a bag making machine and the conveyor. The check weighing section is controlled by a photoelectric eye before and after the check weighing section. A signal from the check weigher instructs the inclined takeaway section to accept or reject the weighed product using a deflecting plate to dispense or contain the product in a secure holding area.

### CROSS REFERENCE TO RELATED APPLICATIONS

This application claims the benefit of provisional patent application Ser. No. 61/197,354, Filed 2008 Oct. 27 by the present inventor.

### FEDERALLY SPONSORED RESEARCH

Not Applicable

### SEQUENCE LISTING OR PROGRAM

Not Applicable

### BACKGROUND

1. Field

This application relates to check weighing conveyors, specifically those which are incorporated into an inclined take away conveyor to convey product from a bag making machine, such as a vertical form fill and seal machine.

2. Prior Art

When a package is made from a bag machine, the finished bag must be conveyed out from the underside of the machine to the check weigher. Ideally, the section of conveyor that the package first touches should be at nearly floor level. This low profile allows for clearance between the seal jaws of the bag machine to keep from deforming the bag as it exits the machine. Additionally, this first conveyor section should preferably be angled to assist in controlling the fall of the finished bag. If the finished bags hit a horizontal conveyor when they drop from a bag machine, some bagged items tend to shift within the bag causing a portion of it to be inaccurately weighed.

Once the bag is clear of the machine, it must be conveyed to a scale section to weigh the bag. Following the weighing of the bag, it must be conveyed to a comfortable height for workers to package the bag into boxes or on a pallet. Since floor space is a concern in most packaging companies, it is the intent of this invention to minimize the horizontal space needed for placement of a check weighing scale without sacrificing package quality or product flow.

U.S. Pat. No. 4,788,930 to Matteau (1988) shows an inclined conveyor which reduces the horizontal space needed for installation, but lacks the adjustable infeed section and the accuracy of a substantially horizontal scale section.

U.S. Pat. No. 3,096,837 to Abbott (1963) shows a horizontal scale section combined with a fixed angle inclined conveyor that is positioned below a horizontal conveyor. This position may cause damage to finished bags due to the vertical drop as well as increasing the functional height of the conveyor system. U.S. Pat. No. 7,048,109 to Brixius (2006) is another example of a fixed incline conveyor albeit for the vastly different application of baggage handling.

The check weighers described in U.S. Pat. No. 3,379,234 to Kasper (1968), U.S. Pat. No. 3,484,813 to Davies (1969), and U.S. Pat. No. 4,065,911 to Fagan (1978) describe improvements primarily to the scale control, but do not address the problem of clearance below a bag making machine.

U.S. Pat. No. 5,304,745 to Rusk (1994) teaches a modular checkweighing and conveying system. Although this invention could be made shorter to allow for clearance between the floor and the bag machine, it lacks the adjustability required to adapt to varying bag lengths and machine types.

### SUMMARY

In accordance with one embodiment a weight checking conveyor with adjustable infeed section comprises three conveyor sections, an infeed section, a check weighing section, and an outfeed or take-away section. The infeed conveyor section is pivotably mounted to a horizontal weight checking conveyor. The angle of the infeed section may be increased to allow positioning under a vertical form fill and seal bag making machine, or decreased to prevent product damage as it falls from the bag making machine. The check weighing conveyor section is preferably horizontal to increase weighing accuracy. The outfeed conveyor section is preferably inclined to deliver finished product to a manageable working height for personnel packing product into shipping cartons.

### DRAWINGS

FIG. 1 is an operator side view of the weight checking conveyor with adjustable infeed section with the side rails and weight checking section cover removed in accordance with one embodiment.

FIG. 2 is a view of the rear of the weight checking conveyor with adjustable infeed section with the side rails and weight checking section cover removed in accordance with one embodiment.

FIG. 3 is a view of the weight checking conveyor with the conveyor belts removed from the infeed, weight checking, and outfeed sections in accordance with one embodiment.

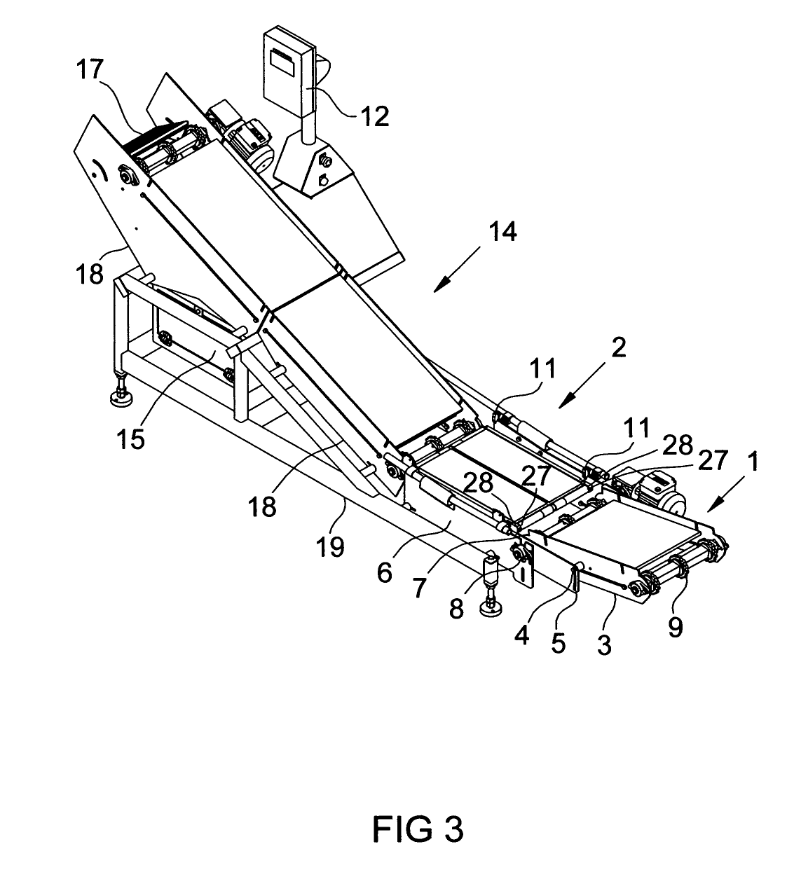

FIG. 4 is a side view of the weight checking conveyor with the front side plate removed from the weight checking section in accordance with one embodiment.

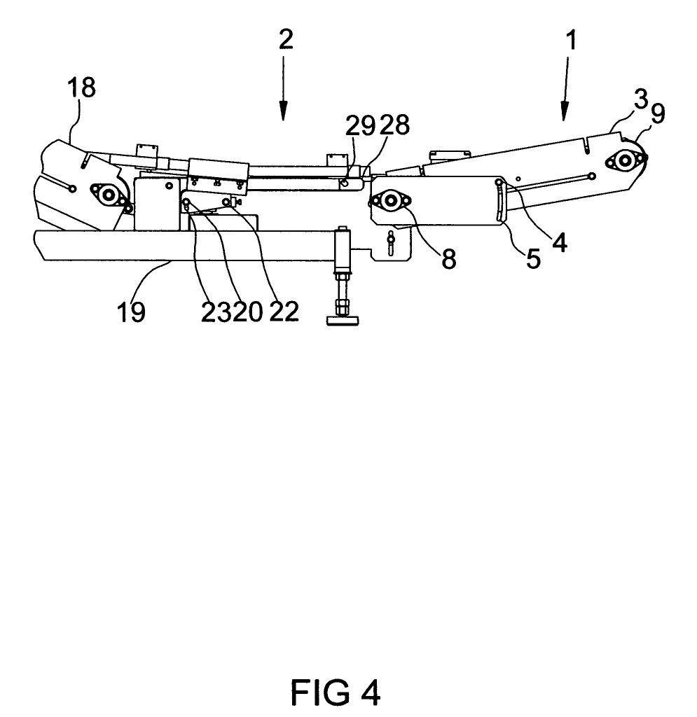

FIG. 5 shows the rear of a fully assembled weight checking conveyor with all side rails and guarding in place in accordance with one embodiment.

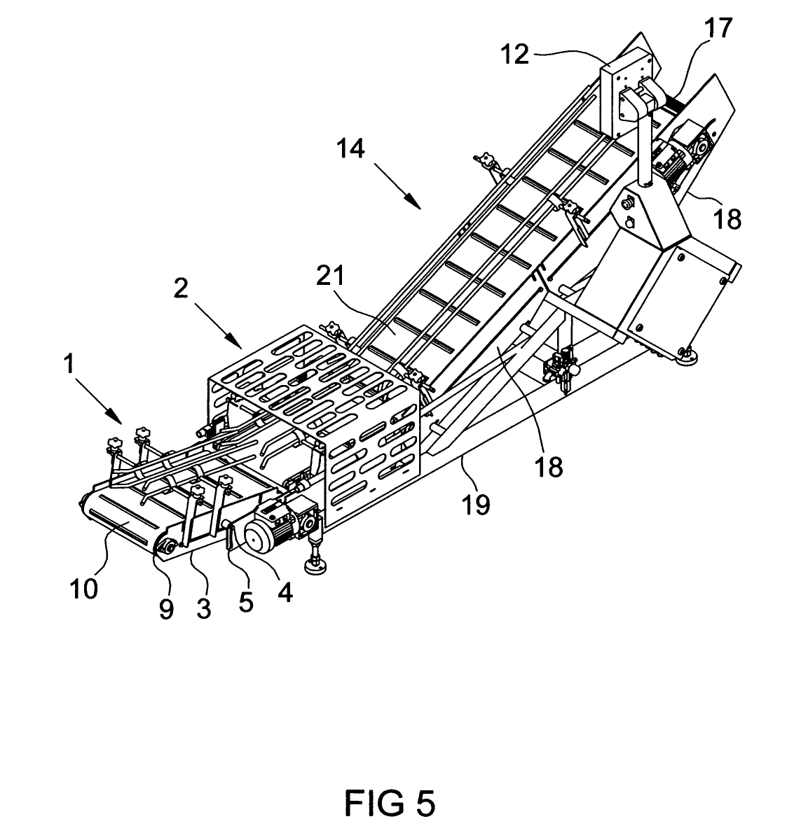

FIG. 6 shows the operator side of a fully assembled weight checking conveyor with all side rails and guarding in place in accordance with one embodiment.

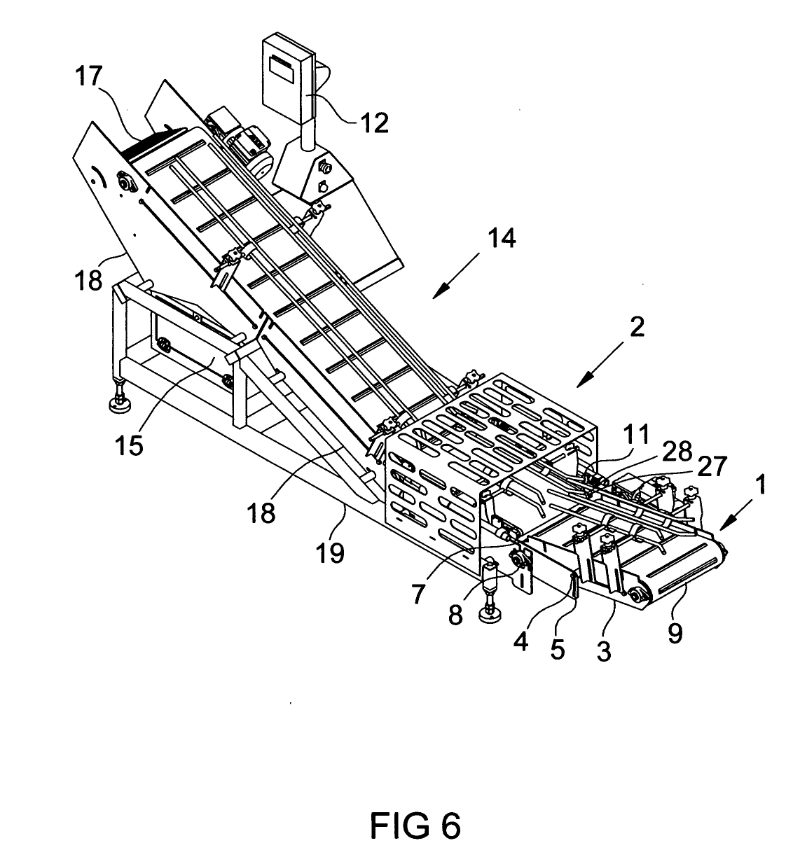

FIG. 7 shows another embodiment of the weight checking conveyor. The primary difference in this view is the use of pivoting roller mounts for facilitating the removal of continuous belts in the infeed, weight checking, and outfeed sections. The outfeed section is shown using two belts.

DRAWINGS - Reference Numerals

| | | | |
|---|---|---|---|
| 1 | infeed section | 2 | check weighing section |
| 3 | infeed section frame | 4 | infeed adjusting bolt |
| 5 | arc shaped slot | 6 | check weighing section frame |
| 7 | infeed drive roller | 8 | flange mounted bearing |
| 9 | infeed idler roller | 10 | infeed conveyor belt |
| 11 | photoelectric sensor | 12 | computer |
| 13 | check weighing section belt | 14 | outfeed conveyor |
| 15 | reject bin | 16 | load cell |
| 17 | pivotal plate | 18 | outfeed conveyor frame |
| 19 | main support frame | 20 | check weighing adjusting bolt |
| 21 | outfeed conveyor belt | 22 | check weighing mounting bolt |
| 23 | check weighing slot | 24 | primary drive pulley |
| 25 | secondary outfeed conveyor | 26 | secondary outfeed drive pulley |
| 27 | roller ends | 28 | pivoting roller mount |
| 29 | tensioner pivot | 30 | primary outfeed section |
| 31 | secondary outfeed section | | |

### DETAILED DESCRIPTION

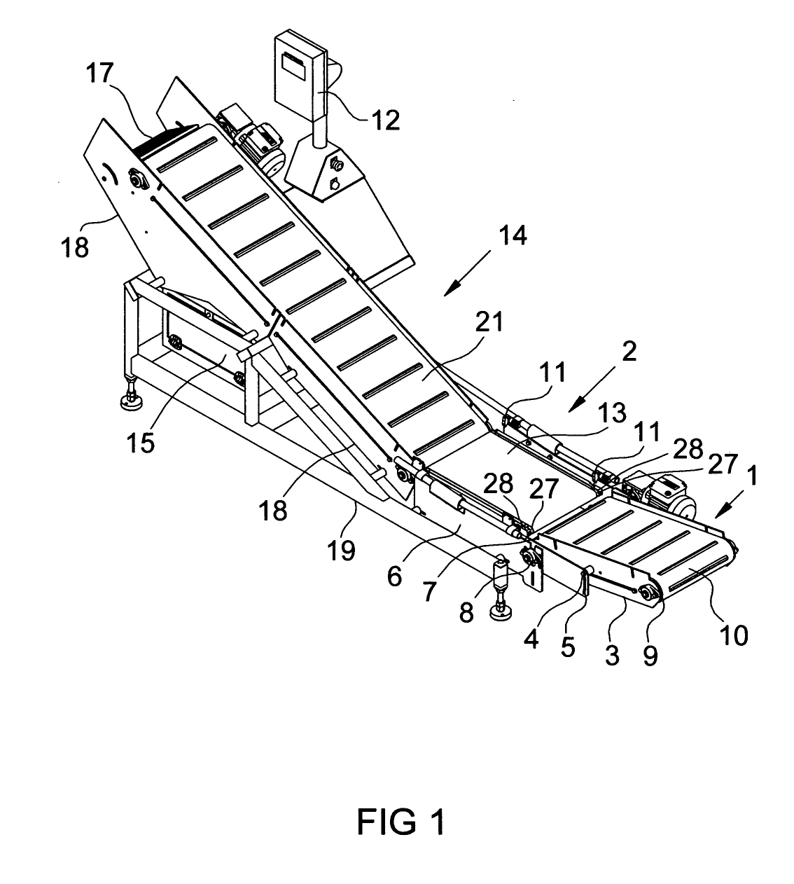

One embodiment of the weight checking conveyor with adjustable infeed section is shown in FIG. 1. The infeed section 1 transports products such as packaged food from a vertical form, fill, and seal machine to the check weighing section 2. The infeed section frame 3 is adjustable to allow it to fit below the exit guards (not shown) of the bag making machine. The pitch or height adjustment is made using an adjustment bolt 4. This adjustment bolt 4 fits through the arc shaped slot 5 in the check weighing section frame 6 to hold the infeed section frame 3 to the check weighing section frame 6. The infeed section frame 3 is allowed to pivot about the same axis as the infeed drive roller 7 using flange mounted bearings 8 fastened to the check weighing section frame 6. Since there are preferably no supports leading from the infeed section 1 of the conveyor to the ground, the infeed idler roller 9 and infeed conveyor belt 10 are able to be placed at nearly floor level reducing the need for additional clearance from the bag making machine.

The check weighing section 2 of the conveyor contains front and rear photoelectric sensors 11 that sense the presence of product on the conveyor and send an electrical signal to output the weight of the product to a computer 12. If desired, the photoelectric sensors 11 can also provide a signal to momentarily stop the check weighing section belt 13 as well.

Once the finished product passes the check weighing section 2 of the conveyor, it is moved upward by an inclined outfeed conveyor 14 to either a secure reject bin 15 or a downstream boxing or palletizing area. The destination of the final package is determined by the check weighing load cell 16 and provides a signal to a pivotal plate 17 that diverts the flow of the package. The secure or lockable reject bin 15 is necessary to prevent tampering of operators that may ship underweight or overweight product to consumers. It is also an advantage to move the product from nearly ground level to the optimum working height of final packaging personnel.

The check weighing section frame 6 and the inclined outfeed conveyor frame 18 is fastened to a main support frame 19. The frames of all sections are preferably made of stainless steel for washdown purposes in a food packing facility.

Since different products require different belts for transporting them, the check weighing section 2 is preferably pivotably mounted to the main conveyor frame 19 with an adjusting bolt 20 at the front and rear of the machine to allow clearance between the outfeed conveyor belt 21 and the check weigh section belt 13. The check weigh section 2 is adjusted by loosening the adjusting bolts 20 and pivoting the check weigh conveyor section 2 slightly about the mounting bolts 22. The length of the slot 23 determines the maximum and minimum degree of rotation relative to the outfeed conveyor 14. The short slot 23 allows for minor clearance adjustments between the check weighing 2 and outfeed conveyor belt 21 but holds the check weighing section 2 substantially horizontal to maintain weighing accuracy.

After adjusting the angle of the check weighing section 2, the assembly is held firmly in place by tightening the adjusting bolts 20 at the operator side and rear of the machine.

The outfeed conveyor 14 is driven by a primary conveyor drive pulley 24 and may consist of a second outfeed conveyor 25 and driven by a secondary conveyor drive pulley 26 also fastened to the main support frame 19.

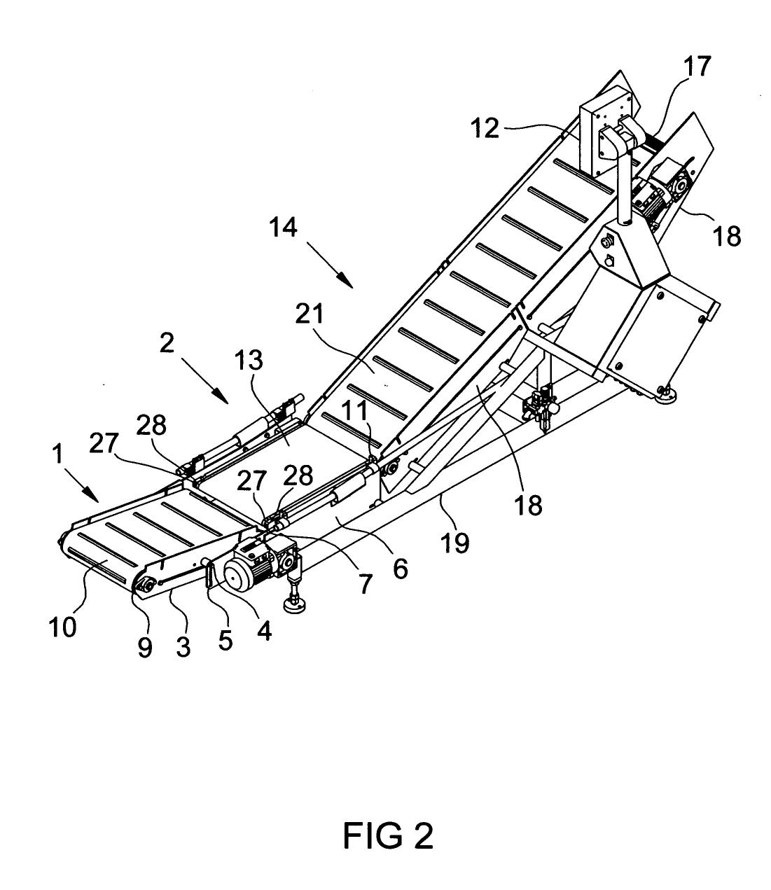

FIG. 1 and FIG. 2 illustrate infeed 10 and outfeed 21 conveyor belts of different construction than the check weighing section belt 13. To remove the infeed 10 or outfeed 21 conveyor belts, a pin is removed from the belt to separate the links. To remove or clean the check weighing section belt 13, the opposing ends 27 of the idler roller 9 are slidably accepted into one end of the pivoting roller mount 28. When the pivoting roller mount 28 is rotated about its pivot point 29 past its over center position, the tension is released in the conveyor belt 13 to allow removal or cleaning under the conveyor belt 13. When the conveyor belt 13 is reinstalled, the pivoting roller mount 28 is rotated back slightly past its over center position effectively locking the idler roller 9 in its position using tension from the conveyor belt 13.

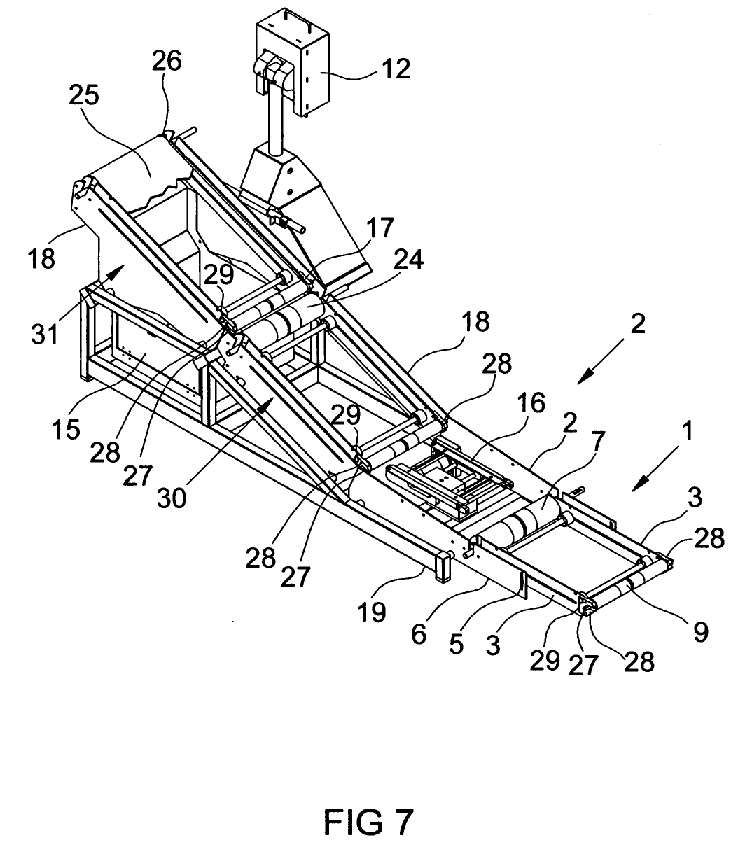

FIG. 7 illustrates an outfeed conveying section comprised of a primary 30 and secondary 31 section using the same non-separating conveyor belts as the check weighing section belt 13. A secondary outfeed section 31 is often desired to separate the finished product being conveyed by increasing its speed relative to the primary outfeed section 30.

I claim:

1. A method of automatically conveying and weighing products comprising:
a. a common frame that houses the frames of a plurality of conveyor sections,
b. a pivotal infeed section comprising a frame, an endless conveyor belt, a driven conveyor belt pulley, and an idler conveyor belt pulley, said infeed section frame pivotal on the axis of said driven conveyor belt pulley of said infeed section, and said infeed section being held in angular position relative to said common frame,
c. a check weighing section comprising a frame, an endless conveyor belt, a driven conveyor belt pulley, and an idler conveyor belt pulley,
d. a substantially inclined take away section comprising a frame, an endless conveyor belt, a driven conveyor belt pulley, and an idler conveyor belt pulley,
whereby said infeed section of said method of automatically conveying and weighing products easily fits under the discharge section of a vertical form fill and seal bag making machine or the like.

2. The method of claim 1 wherein the angle between said pivotal infeed section and said common frame is secured by one or a plurality of threaded fastening means.

3. The method of claim 1 wherein said check weighing section further comprises sensors attached to the leading and trailing end of said check weighing section frame, said sensors selected from the group consisting of photoelectric and proximity sensors to detect the presence or absence of said product on said endless conveyor belt.

4. The method of claim 1 wherein said inclined take away section further comprises a pivotably mounted dihedral plate at the exit end of said endless conveyor belt, whereby said dihedral plate automatically diverts unacceptable product to a storage bin.
